(19) United States
(12) Patent Application Publication
(10) Pub. No.: US 2002/0057830 A1
(43) Pub. Date: May 16, 2002

(54) METHOD AND APPARATUS FOR INSPECTION OF ASSEMBLIES

(76) Inventors: JAMES SHERILL AKIN, ROUND ROCK, TX (US); EDWARD BLAKLEY MENARD, AUSTIN, TX (US)

Correspondence Address: ROBERT V WILDER, 4235 KINGSBURG DRIVE, ROUND ROCK, TX, 78681

(21) Appl. No.: 09/213,315

(22) Filed: Dec. 16, 1998

(51) Int. Cl. G06K 9/00

(52) U.S. Cl. 382/147

(57) ABSTRACT

A method and implementing system is provided in which a circuit board standard image is compared with a test board image and resulting areas where a circuit component is missing from or incorrectly positioned on the circuit board under test, are highlighted on the board being tested for operator inspection. Potentially faulty areas are highlighted by projecting light or light images having predetermined characteristics onto the faulty areas on the board being tested. A model or standard image is acquired by taking an image or digital photo of a circuit board known to have no defects, and comparing the acquired image with an image taken from a circuit board under test. Areas to be highlighted in a second mode are determined from known specifications and other input criteria such as known high defect areas, and this input is programmed into the processing to highlight defect-prone areas on a board being tested. A combination process highlights defect prone areas automatically in addition to illuminating specific board areas where defects are detected through image comparison.

### FIELD OF THE INVENTION

The present invention relates generally to assembly inspection techniques and more particularly to a methodology and implementation for inspecting electronic circuit boards used in electronic devices.

### BACKGROUND OF THE INVENTION

Increased miniaturization and complexity of electronic devices in general, including computer related equipment such as laptop computers, hand-held or palm-top computers, organizers and the like, is driving circuit board densities higher and component sizes smaller. As a result, testability of circuit boards and cards which are mounted within such electronic devices, has been substantially reduced due in part to a reduction in unused board area which may otherwise have been used for test points in testing the circuit board. Manual inspection of the boards is also made more difficult since inspection station operators must look at more components of a smaller size on each circuit board. In addition, certain components such as de-coupling capacitor components cannot be tested at all and must be manually inspected.

Manual inspection, though prevalent, is tedious and the results of such manual inspections vary depending, inter alia, on individual operators and their ability to fully concentrate during the manual board inspection process. Missing components, particularly passive chip-type components, are a particular problem due to their small size as well as the inability to test certain components, such as de-coupling capacitors, with in-circuit test equipment.

Thus, there is a need for an improved methodology and implementing system which is effective to provide an improved circuit card inspection technique for automatically and accurately identifying areas on circuit boards being tested which may have been improperly assembled.

### SUMMARY OF THE INVENTION

A method and implementing system is provided in which a circuit board standard image is compared with a test board image and resulting areas where a circuit component is missing from or incorrectly positioned on the circuit board under test, are highlighted on the board being tested for operator inspection. Potentially faulty areas are highlighted by projecting light or light images having predetermined characteristics onto the faulty areas on the board being tested. A model or standard image is acquired by taking an image or digital photo of a circuit board known to have no defects, and comparing the acquired image with an image taken from a circuit board under test. Areas to be highlighted in a second mode are determined from known specifications and other input criteria such as known high defect areas, and this information is programmed into the processing to highlight defect-prone areas on a board being tested. A combination process highlights defect prone areas automatically in addition to illuminating specific board areas where defects are detected through image comparison.

### BRIEF DESCRIPTION OF THE DRAWINGS

A better understanding of the present invention can be obtained when the following detailed description of a preferred embodiment is considered in conjunction with the following drawings, in which:

FIG. 1 is a diagram of an exemplary embodiment of a circuit board inspection station in which the present invention may be implemented;

FIG. 2 is a flow chart illustrating an exemplary operational sequence in accordance with one mode of the present invention;

FIG. 3 is a flow chart illustrating an exemplary operational sequence in accordance with a second mode of the present invention; and

FIG. 4 is an illustration of a combination mode for the exemplary test station implemented in accordance with the present invention.

### DETAILED DESCRIPTION

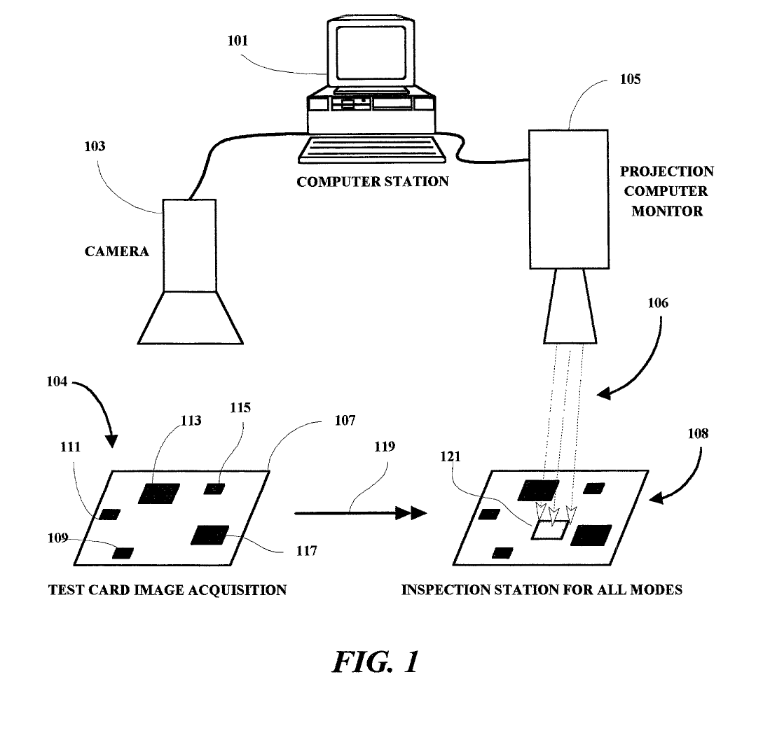

With reference to FIG. 1, the various methods discussed herein may be implemented to include a typical computer system which may include a workstation or personal computer 101. In general, an implementing computer system may include a plurality of processors in a multi-bus system in a network of similar systems. However, since the workstation or computer system 101 implementing the present invention in an exemplary embodiment, is generally known in the art and composed of electronic components and circuits which are also generally known to those skilled in the art, circuit details beyond those shown in FIG. 1, are not specified to any greater extent than that considered necessary as illustrated, for the understanding and appreciation of the underlying concepts of the present invention and in order not to obfuscate or distract from the teachings of the present invention.

As is also shown in FIG. 1, the workstation 101 is connected to a camera device 103 which may be a digital camera in the present example. The camera 103 is selectively operable to acquire an image of a circuit board 107 upon which the camera 103 is focussed. The camera 103 in combination with the computer station 101 is then selectively operable to create a digital file representative of the image acquired of the circuit board 107. The circuit board 107 is shown to include several electronic components mounted thereon including components 109, 111, 113, 115 and 117. In the present example, the components are integrated circuits (ICs) or “chips” which are mounted in specific locations on the circuit board as represented, in accordance with a specification for the assembly of the circuit board being tested. After an image is acquired, the circuit board 107 is moved to a position or area 108.

The computer station is connected to a projection computer monitor 105 which is arranged to project an image via light rays 106 onto the area 108. The projection computer monitor or projector device 105 may be any of many which are commercially available such as an NEC® MultiSync™ MT600 LCD projector or a Proxima Lightbook™ projector. The projector device is connected to the computer station 101 and is selectively operable to project an image onto the circuit board in accordance with an output from the computer station 101. Alternate embodiments may be designed in which the circuit board 107 remains at one location and the camera 103 and projector 105 are moved to receive light and project light, respectively, onto the circuit board 107.

In the example shown in FIG. 1, a picture or image is taken from a circuit board 107 under test at position 104. The image is processed within the computer station 101 and compared to a “master” image of a known “good” circuit board. Corresponding elements between the acquired image and the master image are cancelled out in the example and the computer output from the computer station 101 is effective to cause the projector 105 to project light 106 onto the circuit board 107 at position 108 representative of only the differences between the master image and the acquired image. As shown in the example, the circuit board in accordance with a master file includes a device at area 121 which is not present on the board 107. Accordingly, when the acquired image and the master image are compared at the computer station 101, it is determined that the image comparisons do not match in the area 121 of the board. Accordingly, the computer station 101 causes the projector 105 to project light 106 on the area 121 of the circuit board 107. This will alert an inspector at the station that something is missing and the operator can take appropriate action such as simply rejecting the faulty circuit board. The processing is also designed to highlight an area on the circuit board where a component may not be called for by the master image but a component may have been mistakenly mounted in a given area on the board and detected in the acquired image. In that case, projected light would focus upon the area of the board where the misplaced or incorrectly placed component or part is located and an inspector may take appropriate action by rejecting the board or removing the inappropriately placed board component.

Although the fault detection technique disclosed herein is primarily designed to be of maximum benefit in a manual inspection process, it is noted that the fault condition may also be detected automatically and the circuit board may also be rejected automatically in a fully mechanized operation. The advantage of the computer processing and the minimal projection in accordance with only variances between an acquired image and a master model image is that only faults are highlighted rather than projecting images of all of the components of a circuit board. With only fault highlighting, there is a much lower chance for error in detecting the faulty condition either mechanically or by an human inspector.

Using the projection system, light can be projected onto the circuit board being inspected in patterns of light to assist an operator in quickly finding component locations to be inspected. The projected light could be all of the same color or various colors could indicate different types of inspection to be performed. For example, for a resistor, an area may be illuminated in one color while for an IC, the illuminating light may be of a different color.

In the disclosed example, two methods can be used to determine a pattern of light to be displayed. The first method is a direct programming of the patterns which is data driven. A system programmer would define locations to be inspected by operators. For example, only capacitor locations on a circuit board may be projected. Another example would be to project locations for components known to have a high probability of a defect. Also, this technique allows various component locations to be projected in various colors to indicate different component types or values.

The second method is a “data-less” method in that the master image data is not programmed into the computer station but is created by acquiring an image from a “gold board” or known “good” board through the use of a digital camera. Then an image of a board under test is acquired. The two images are then aligned and the two images are compared. The comparison is implemented in the example by using correlation software to align the boards and then image processing software to compare the image files. Where a component is present on both the “gold” board and the board under test, the area on the board would not be illuminated. However, where there is a missing part, the appropriate board area would be illuminated indicating a detected difference between the “gold” board and the current board under test.

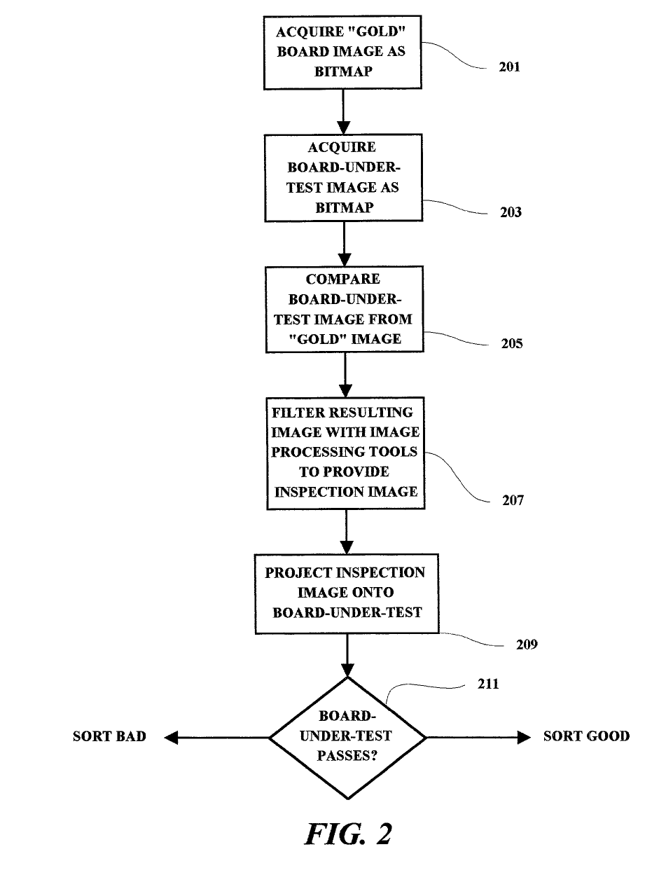

An exemplary flow chart for the disclosed methodology is illustrated in FIG. 2. As shown, when the “data-less” process begins, a “gold” board image is acquired as a bitmap 201. Next the bitmap image of a board-under-test is acquired 203 and the two images are compared 205 to provide an output which is filtered as appropriate to provide an inspection image 207 which is then projected 209 onto the board under test. A determination can then be made 211 by an inspector (or through automated means) as to whether the board sorts “good” or “bad”.

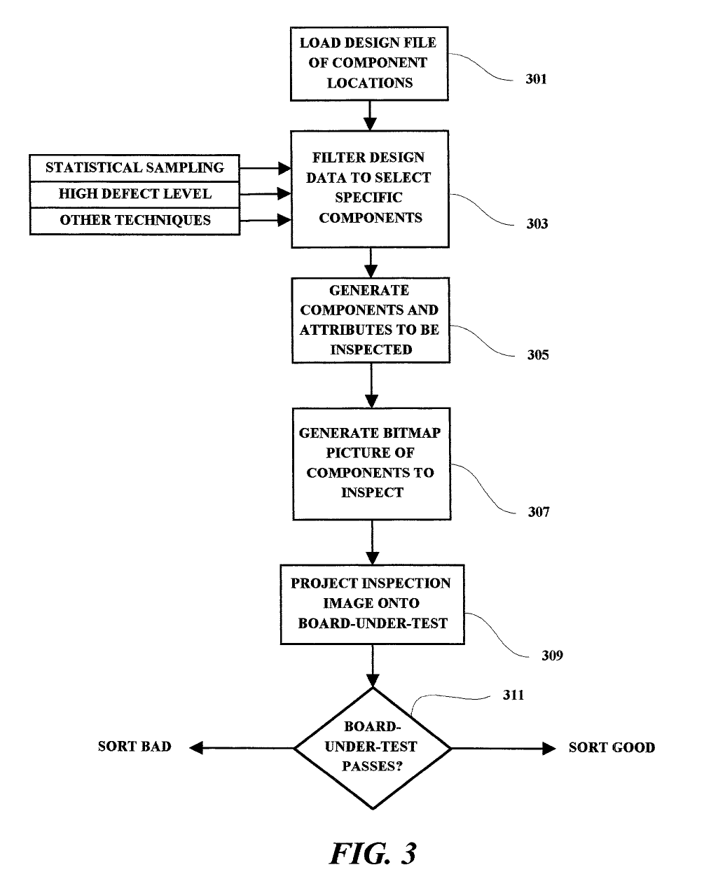

In another example as shown in FIG. 3, a data driven process begins by loading 301 a design file of component locations into a computer station 101. Next, the design data is filtered 303 to select specific components in accordance with inputs such as statistical sampling, high defect level areas or other techniques. Next, components and attributes to be inspected are generated 305 and a bitmap picture of those components is generated 307. An inspection image is projected onto a board being tested 309 and a determination is made 311 as to whether the board sorts good or bad. Using this method, board areas in which high defect levels have been occurring, can be factored or programmed into the inspection process for new boards thereby providing fast feedback from subsequent electrical testing and field installations, and correcting defect-prone board areas in a quick and efficient manner.

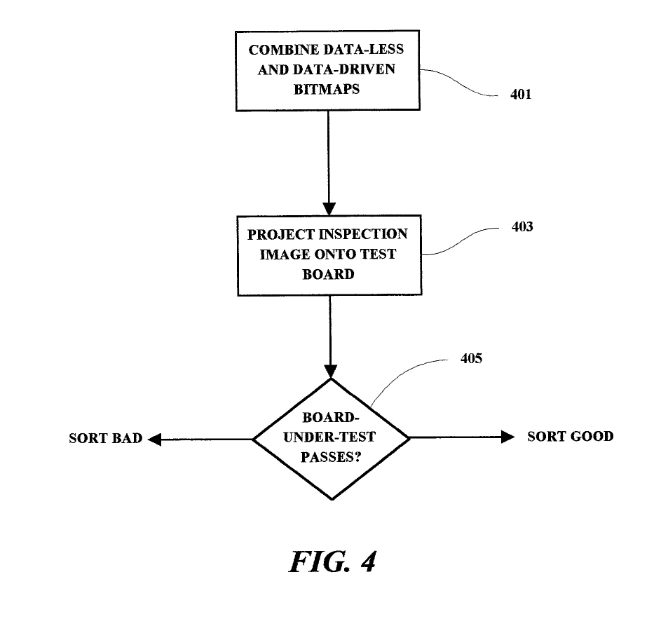

In a combination methodology as illustrated in FIG. 4, data-less (“gold card”) and data-driven or programmed bitmaps are first combined 401 to provide an inspection image to be projected onto a test board 403 to determine good and faulty boards 405. Using the combination methodology, missing or improperly placed parts can be highlighted on a test board as well as having high defect rate area highlighted and checked by an inspector even though a fault is not detected by the master-test board image comparison.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely in program code stored on a disk or diskette (portable or fixed), or other memory device, from which it may be executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for inspecting an assembled circuit board, said method comprising:
obtaining an acquired image of said circuit board;
comparing said acquired image with a master image, said master image being representative of a desired board image; and
projecting light on said circuit board, said light being projected to illuminate one or more areas on said circuit board where a variance is detected from said comparing of said acquired image and said master image.

2. The method as set forth in claim 1 wherein said master image is obtained with a camera device.

3. The method as set forth in claim 2 wherein said camera device is a digital camera.

4. The method as set forth in claim 1 wherein said projected light is varied according to predetermined criteria, said predetermined criteria being related to various aspects of said inspecting.

5. The method as set forth in claim 4 wherein said projected light is varied by changing a color associated with said projected light.

6. The method as set forth in claim 4 wherein said projected light is made to repetitively flash on and off while being projected at said one or more areas of said circuit board.

7. The method as set forth in claim 4 wherein said projected light is comprised of laser light.

8. The method as set forth in claim 1 wherein said comparing is accomplished at a computer station, said method further including:
projecting light on selected predetermined areas of said circuit board, said predetermined areas being determined in accordance with information programmed into said computer station independently of said comparing of said acquired image with said master image.

9. A method for inspecting an assembled circuit board, said method comprising:
providing input to a computer device; and
projecting light onto said circuit board in response to said input to said computer device, said light being projected to illuminate one or more areas on said circuit board, said computer input being representative of areas on said circuit board which require particular attention by an inspector.

10. An inspection station for inspecting circuit boards, said inspection station comprising:
a camera device arranged to obtain an acquired image of a circuit board being tested;
a computer device coupled to said camera device, said computer device being selectively operable for comparing said acquired image with a master image, said master image being representative of a desired board image; and
a light projecting device coupled to said computer device, said light projecting device being operable in response to output from said computer device for projecting light on said circuit board, said light being projected to illuminate one or more areas on said circuit board where a variance is detected from said comparing of said acquired image and said master image.

11. The inspection station as set forth in claim 10 wherein said master image is obtained with said camera device.

12. The inspection station as set forth in claim 11 wherein said camera device is a digital camera.

13. The inspection station as set forth in claim 10 wherein said projected light is varied according to predetermined criteria, said predetermined criteria being related to various aspects of said inspecting.

14. The inspection station as set forth in claim 13 wherein said projected light is varied by changing a color associated with said projected light.

15. The inspection station as set forth in claim 13 wherein said projected light is made to repetitively flash on and off while being projected at said one or more areas of said circuit board.

16. The inspection station as set forth in claim 13 wherein said projected light is comprised of laser light.

17. The inspection station as set forth in claim 10 and further including:
projecting light on selected predetermined areas of said circuit board, said predetermined areas being determined in accordance with information programmed into said computer device independently of said comparing of said acquired image with said master image.

18. An inspection station for inspecting circuit boards, said inspection station comprising:
a computer device; and
a light projecting device coupled to said computer device, said light projecting device being operable in response to output from said computer device for projecting light on said circuit board, said light being projected to illuminate one or more areas on said circuit board in accordance with computer input to said computer device, said computer input being representative of areas on said circuit board which require particular attention by an inspector.

19. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective to identify inspection areas on a circuit board which are to be highlighted for further inspection, said program signals being selectively operable when applied to said processing circuitry, to effect the steps of:
obtaining an acquired image of said circuit board;
comparing said acquired image with a master image, said master image being representative of a desired board image; and
projecting light on said circuit board, said light being projected to illuminate one or more areas on said circuit board where a variance is detected from said comparing of said acquired image and said master image.
